(19) United States
(12) Patent Application Publication
(10) Pub. No.: US 2018/0060719 A1
(43) Pub. Date: Mar. 1, 2018

(54) SCALE-SPACE LABEL FUSION USING TWO-STAGE DEEP NEURAL NET

(71) Applicant: International Business Machines Corporation, Armonk, NY (US)

(72) Inventors: Pavel Kisilev, Maalot (IL); Eliyahu Sason, Kiryat Ata (IL)

(21) Appl. No.: 15/249,507

(22) Filed: Aug. 29, 2016

(51) Int. Cl. G06N 3/04

(52) U.S. Cl. CPC G06N 3/04

(57) ABSTRACT

Embodiments may provide methods by which fusion of information may be applied to uncertainty reduction in the results of classifier-based data analysis. For example, a method for data analysis may comprise generating a plurality of sets of data samples, each set of data samples representing a portion of input data at plurality of scales, each data sample in a set may represent the portion of the input data at a different scale and location, generating a feature map from each data sample of at least one set of data samples by learning and aggregating features using a first multi-layer convolutional processing, each data sample may be processed with multi-layer convolutional processing separately from other data samples, and generating a feature map by combining the feature maps from the data samples of each set of data samples by performing multiple-scale-multiple-location label fusion using a second multi-layer convolutional processing.

### BACKGROUND

The present invention relates to techniques for using two stages of multi-layer convolutional neural network processing in conjunction with fusion of information techniques so as to achieve uncertainty reduction in the results of classifier-based data analysis techniques.

Classifier-based data analysis systems are typically used to create a model, which given a minimum amount of input data/information, is able to produce correct decisions. One approach to utilizing such systems depends upon continuous development of existing classification and model-building techniques, as well as the discovery of new techniques. Another approach suggests that as the limits of the existing individual techniques are approached, and since it is hard to develop new better techniques, it may be advantageous to combine existing well-performing methods, in the hope that better results will be achieved. Such techniques may be known as information fusion techniques.

Classifier-based data analysis techniques typically produce results including a significant amount of potential error or uncertainty. A need arises for techniques by which such error or uncertainty may be reduced, so as to provide better quality results from such techniques.

### SUMMARY

Embodiments of the present invention may provide techniques by which error or uncertainty in the results of classifier-based data analysis techniques may be reduced, so as to provide better quality results from such techniques. For example, in an embodiment, fusion of information techniques may be applied to uncertainty reduction in the results of classifier-based data analysis techniques. Each of individual data analysis technique produces some errors, even if the input information is not corrupted or incomplete. However, different technique being applied to different data should produce different errors, and assuming that each individual technique performs well, the combination of such multiple techniques should reduce overall classification error and uncertainty and result in higher-quality results.

For example, in an embodiment of the present invention, a computer-implemented method for data analysis may comprise receiving input data, generating a plurality of sets of data samples, each set of data samples representing a portion of the received input data at plurality of scales, wherein each data sample in a set represents the portion of the received input data at a different scale, generating a feature map from each data sample of at least one set of data samples by learning and aggregating features using a first multi-layer convolutional processing, wherein each data sample may be processed with multi-layer convolutional processing separately from other data samples, and generating a feature map for the at least one set of data samples by combining the feature maps from the data samples of each set of data samples by performing multiple-scale-multiple-location label fusion using a second multi-layer convolutional processing.

In an embodiment, the data samples in each set of data samples may be overlapping data samples, or the data samples in each set of data samples may be non-overlapping data samples. Each layer of convolutional processing of the first multi-layer convolutional processing may comprise at least one type of processing selected from a set comprising convolutional layer processing, pooling layer processing, Rectified Linear Units layer processing, dropout layer processing, and loss layer processing. Each layer of convolutional processing of the second multi-layer convolutional processing may comprise at least one type of processing selected from a set comprising convolutional layer processing, pooling layer processing, Rectified Linear Units layer processing, dropout layer processing, and loss layer processing, and wherein the second multi-layer convolutional processing and the second multi-layer convolutional processing may comprise different layers of convolutional processing. The input data may comprise image data.

In an embodiment of the present invention, a computer program product for data analysis may comprise a non-transitory computer readable storage having program instructions embodied therewith, the program instructions executable by a computer, to cause the computer to perform a method comprising receiving input data, generating a plurality of sets of data samples, each set of data samples representing a portion of the received input data at plurality of scales, wherein each data sample in a set represents the portion of the received input data at a different scale, generating a feature map from each data sample of at least one set of data samples by learning and aggregating features using a first multi-layer convolutional processing, wherein each data sample is processed with multi-layer convolutional processing separately from other data samples, and generating a feature map for the at least one set of data samples by combining the feature maps from the data samples of each set of data samples by performing multiple-scale-multiple-location label fusion using a second multi-layer convolutional processing.

In an embodiment of the present invention, a system for predicting metastasis of a cancer may comprise a processor, memory accessible by the processor, and computer program instructions stored in the memory and executable by the processor to perform receiving input data, generating a plurality of sets of data samples, each set of data samples representing a portion of the received input data at plurality of scales, wherein each data sample in a set represents the portion of the received input data at a different scale, generating a feature map from each data sample of at least one set of data samples by learning and aggregating features using a first multi-layer convolutional processing, wherein each data sample is processed with multi-layer convolutional processing separately from other data samples, and generating a feature map for the at least one set of data samples by combining the feature maps from the data samples of each set of data samples by performing multiple-scale-multiple-location label fusion using a second multi-layer convolutional processing.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary flow diagram of a process according to an embodiment of the present invention.

FIG. 2 is an exemplary block diagram of a first stage of Convolutional Neural Net processing.

FIG. 3 is an exemplary block diagram of a second stage of Convolutional Neural Net processing.

FIG. 4 is an exemplary block diagram of a computer system in which processes involved in the embodiments described herein may be implemented.

### DETAILED DESCRIPTION

Embodiments of the present invention may provide techniques by which error or uncertainty in the results of classifier-based data analysis techniques may be reduced, so as to provide better quality results from such techniques. For example, in an embodiment, fusion of information techniques may be applied to uncertainty reduction in the results of classifier-based data analysis techniques. Each of individual data analysis technique produces some errors, even if the input information is not corrupted or incomplete. However, different technique being applied to different data should produce different errors, and assuming that each individual technique performs well, the combination of such multiple techniques should reduce overall classification error and uncertainty and result in higher-quality results.

For example, an embodiment of the present invention may involve a novel scale-space label fusion method, which is based on a two-stage Convolutional Neural Net (CNN) system. The first stage may contain several convolutional and fully connected layers, and may serve to learn and aggregate features in multiple scales and locations. The second stage, which also may contain several convolutional layers, may act on the first layer score output maps, and may perform label fusion, which may also be performed in a multiple-scale-multiple-location manner.

Embodiments of the present invention may provide the capability to automatically learn spatial relationships of data, such as images, for example by areas and pixels that are to be classified. Further, embodiments of the present invention may provide the capability to learn connections and relationships between labels from the first stage CNN processing, which may learn relationships and label space features automatically during the supervised training process.

A CNN system is a type of feed-forward artificial neural network which may be used in machine learning. Typically, the connectivity pattern between the neurons in a CNN system is generally based on the organization of the visual cortex of organisms. In a visual cortex, individual neurons may be arranged in such a way that they respond to overlapping regions or tiles of the visual field. CNN systems may be used in applications such as image recognition, recommendation generating systems, and natural language processing.

Compared to other classification algorithms, convolutional neural networks may use relatively little pre-processing. The network may perform the work of learning the filters that in conventional techniques may have been hand-crafted.

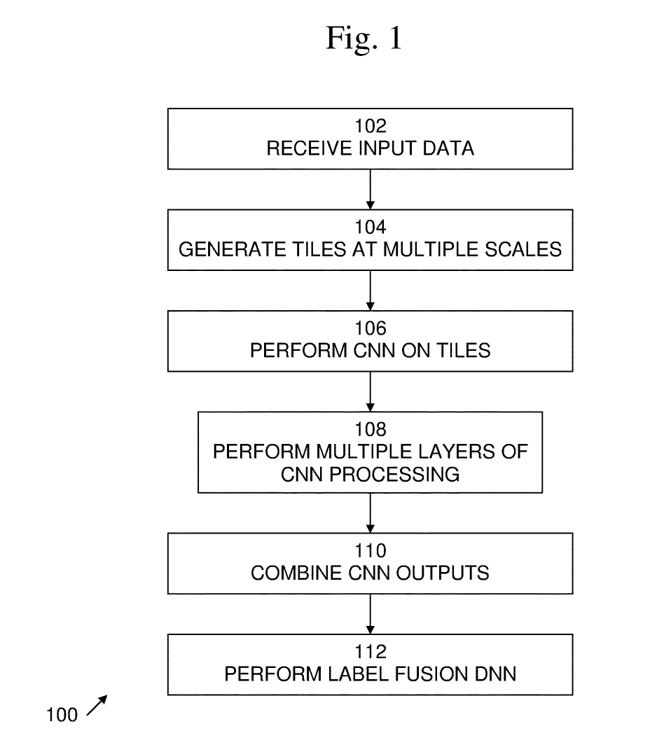

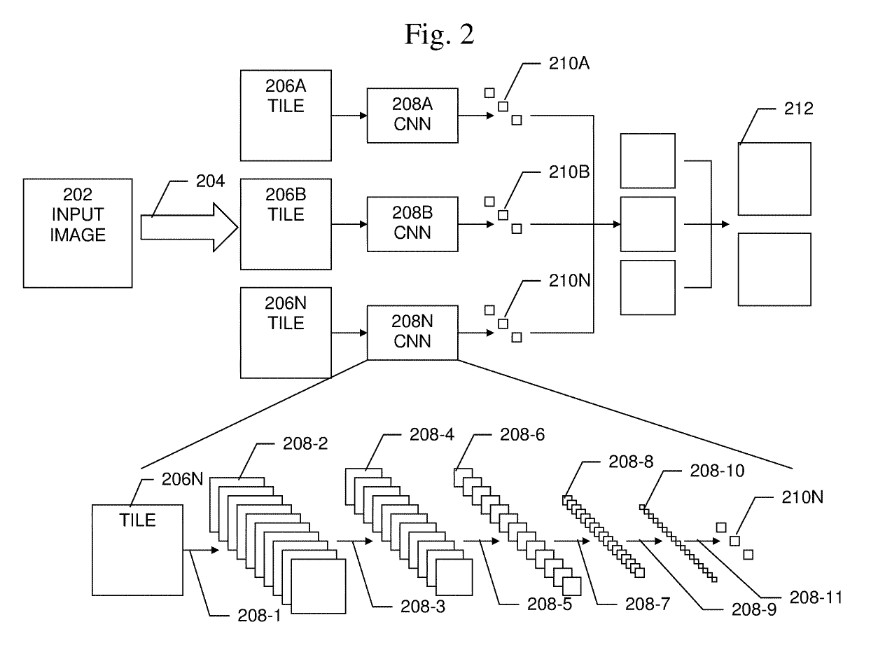

An exemplary flow diagram of a process 100 according to an embodiment of the present invention is shown in FIG. 1. It is best viewed in conjunction with FIG. 2, which is an exemplary block diagram of a first stage of CNN processing. For clarity, the processes and structures utilized by the present invention are described in the context of image recognition. However, this is merely an example of the application of the present invention. Rather, the present invention contemplates application to any type of data.

Process 100 begins with 102, in which input data, such as input image 202, may be received. At 104, the input image 202 may be divided up 204 into a plurality of overlapping or non-overlapping tiles 206A-N at different scales. Each set of tiles may be considered to form a group of tiles, which may be a multi-scale representation of a portion or sub-portion of input image 202. For example, input image 202 may be divided into a plurality of overlapping or non-overlapping tiles at a first scale, a plurality of overlapping or non-overlapping tiles at a second scale, etc. Tiles at different scales, but representing the same portion of input image 202 may be processed as a group. For example, tile 206A may represent a particular portion of input image 202 at a first scale. Tile 206B may represent that same portion of input image 202 (or a sub-portion of the portion) at a second scale. Tile 206N may represent that same portion of input image 202 (or the sub-portion or a different sub-portion of the portion) at a third scale, and so on.

At 106, each group of tiles 206A-N comprising a multi-scale representation of a portion of input image 202 may be processed using CNN processing 208A-N, respectively. For example, tile 206A, at a first scale, may be processed with CNN processing 208A, tile 206B, at a second scale, may be processed with CNN processing 208B, tile 206N, at a third scale, may be processed with CNN processing 208N. CNNs may include multiple layers of processing, each of which may process portions of the input image. The outputs of these collections may then be tiled so that their input regions overlap. This may produce a better representation of, for example, the original image. Typically the tiling and overlapping, if any, may be repeated for every such layer. CNN processing 208A-N may be considered to be a first stage of CNN processing, in which features in input image 202 may be learned and aggregated in multiple scales and locations. The output of the CNN processing may include labeling of features within the input images as being of interest.

First stage CNN processing 208A-N is shown in more detail at 208-1 to 208-11. In this example, a tile 208N is input to CNN processing. For example, tile 208N may be a 36×36 pixel portion of the original input image at a particular scale. A first layer of processing 208-1 may be performed. For example, the processing may include a convolutional layer, a pooling layer, and a Rectified Linear Units (ReLU) layer.

The convolutional layer is a core processing layer of a CNN. The convolutional layer may perform processing using a set of convolution matrices that may be trained using the input image. For example, during a first pass, each filter may be convolved across the width and height of the input image, and may compute the dot product between the entries of the filter and the input image to produce a 2-dimensional activation map of that filter. As a result, the convolutional layer may train convolution matrices that activate when they see some specific type of feature at some spatial position in the input.

Another processing layer of CNNs is the pooling layer. The pooling layer essentially performs a type of non-linear down-sampling. A number of non-linear functions may be used to implement pooling. For example, a non-linear function known as max pooling may partition the input image into a set of non-overlapping rectangles and, for each such sub-region, output the maximum. The pooling layer thus progressively reduces the spatial size of the representation, which reduces the amount of data and computation that is necessary for processing, and also to control overfitting. The pooling layer may instead, or in addition, perform other non-linear functions, such as average pooling and L2-norm pooling.

The ReLU layer may perform processing that applies a non-saturating activation function, such as f(x)=max(0, x). This may increase the nonlinear properties of the decision function and of the overall neural network without affecting the convolution layer. Other functions may also be used to increase nonlinearity. For example, the saturating hyperbolic tangent, f(x)=tan h(x), f(x)=|tan h(x)|, and the sigmoid function f(x)=(1+e⁻¹. The use of ReLU is advantageous, as it may increase the training speed of the neural network.

For example, at 208-1, an input tile of 36×36 pixels may be input, processed by, for example, a convolutional layer, a pooling layer, and a ReLU layer, and a plurality of tiles 208-2 output, such as 32 tiles of 16×16 pixels. At processing layer 208-3, tiles 208-2 may be input, processed by, for example, a convolutional layer and a ReLU layer, and a plurality of tiles 208-4 output, such as 32 tiles of 12×12 pixels. At processing layer 208-5, tiles 208-4 may be input, processed by, for example, a convolutional layer and a ReLU layer, and a plurality of tiles 208-6 output, such as 32 tiles of 8×8 pixels. At processing layer 208-7, tiles 208-6 may be input, processed by, for example, a convolutional layer and a ReLU layer, and a plurality of tiles 208-8 output, such as 64 tiles of 4×4 pixels. At processing layer 208-9, tiles 208-8 may be input, processed by, for example, a dropout layer and a ReLU layer, and a plurality of tiles 208-10 output, such as 512 tiles of 2×2 pixels. At processing layer 208-11, tiles 208-10 may be input and processed by, for example, a loss layer, to generate output 210N.

A dropout layer of processing may be performed to prevent overfitting. In dropout processing, individual nodes may be either “dropped out” of the neural network with probability 1-p or kept with probability p, so that a reduced network is left Likewise, incoming and outgoing edges to a dropped-out node may also be removed. The reduced network may be trained on the data in that stage. The removed nodes may then be reinserted into the network with their original weights. By avoiding training all nodes on all training data, dropout may decrease overfitting in neural networks and may also significantly improve the speed of training.

A loss layer may specify how the CNN training penalizes the deviation between the predicted and true labels and is typically the last layer in the CNN processing. Various loss functions appropriate for different tasks may be used. For example, Softmax loss may be used for predicting a single class of K mutually exclusive classes. Sigmoid cross-entropy loss may be used for predicting K independent probability values. Euclidean loss may be used for regressing to real-valued labels.

Each output 210A-N represents a CNN processed tile at a particular scale from the group of tiles 206A-N. Accordingly, the group of outputs 210A-N is a multi-scale CNN processed representation of a portion (or sub-portion) of input image 202. As a result of the CNN processing, each output 210A-N may include one or more features that have been labeled as being of interest and scored as to their levels of interest and confidence. Due to the differing scales, different features may have been labeled as being of interest in each output 210A-N, the same features may have been labeled or scored differently at the different scales, some features may have been missed at some of the scales, etc. At 110 of FIG. 1, the outputs 210A-N, each of which may be have a different scale, may be combined in one or more ways to generate one or more CNN processed combined tiles 212, each of which may include a feature label and score output map.

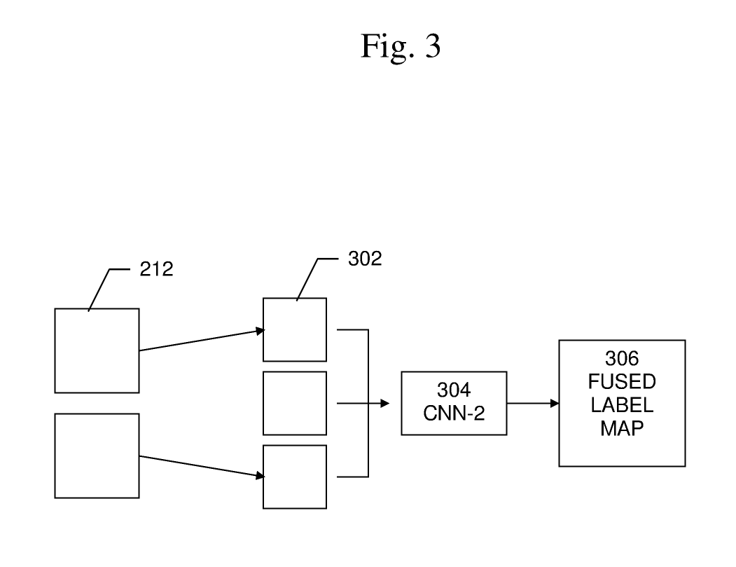

At 112, label fusion deep neural network learning may be performed. Turning to FIG. 3, feature label and score output maps 212, which may have been generated by combining the outputs from the first stage CNN processing in different ways, and feature label and score output maps representing a plurality of portions of input image 202, may be combined and processed using a second stage of CNN processing 304. The second stage of CNN processing 304, which may contain several convolutional layers (e.g. two or more layers) of processing, may act on the first stage feature label and score output maps 212, and may perform label fusion in a multiple-scale-multiple-location manner. The output from the second stage of CNN processing 304 may include one or more fused label maps 306. As the feature label and score output maps 212 are generated at different scales, the convolutional processing performed to combine feature label and score output maps 212 in a multiple-scale-multiple-location manner, may reduce overall classification error and as a consequence emphasize correct outputs.

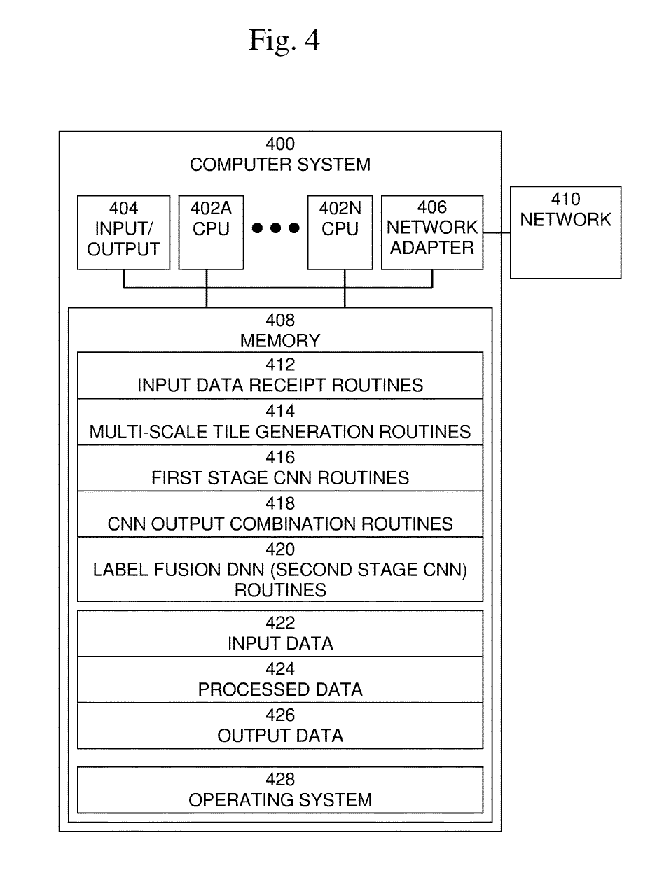

An exemplary block diagram of a computer system 400, in which processes involved in the embodiments described herein may be implemented, is shown in FIG. 4. Computer system 400 is typically a programmed general-purpose computer system, such as an embedded processor, system on a chip, personal computer, workstation, server system, and minicomputer or mainframe computer. Computer system 400 may include one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which computer system 400 is implemented as a single multi-processor computer system, in which multiple processors 402A-402N share system resources, such as memory 408, input/output circuitry 404, and network adapter 406. However, the present invention also contemplates embodiments in which computer system 400 is implemented as a plurality of networked computer systems, which may be single-processor computer systems, multi-processor computer systems, or a mix thereof.

Input/output circuitry 404 provides the capability to input data to, or output data from, computer system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of computer system 400. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 may vary depending upon the function that computer system 400 is programmed to perform. For example, as shown in FIG. 1, computer systems may perform a variety of roles in the system, method, and computer program product described herein. For example, computer systems may perform one or more roles as end devices, gateways/base stations, application provider servers, and network servers. In the example shown in FIG. 4, exemplary memory contents are shown representing routines and data for all of these roles. However, one of skill in the art would recognize that these routines, along with the memory contents related to those routines, may not typically be included on one system or device, but rather are typically distributed among a plurality of systems or devices, based on well-known engineering considerations. The present invention contemplates any and all such arrangements.

In the example shown in FIG. 4, memory 408 may include input data receipt routines 412, multi-scale tile generation routines 414, first stage CNN routines 416, CNN output combination routines 418, label fusion DNN (second stage CNN) routines 420, input data 422, processed data 424, output data 426, and operating system 428. For example, input data receipt routines 412 may include routines to receive and process input data 422, such as input images 204, shown in FIG. 2. Multi-scale tile generation routines 414 may include routines to divide up input data 422, such as input images 204, into a plurality of overlapping or non-overlapping tiles at different scales. First stage CNN routines 416 may include routines to perform multiple layers of first stage CNN processing. Each layer may generate and use processed data 424. CNN output combination routines 418 may include routines to combine, in one or more ways, the outputs of the CNN processing, which may include feature label and score output maps. Label fusion DNN (second stage CNN) routines 420 may include routines to perform label fusion in a multiple-scale-multiple-location manner using multiple layers of second stage CNN processing, and to generate output data 426, which may include fused label maps 306, shown in FIG. 3. Operating system 428 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for data analysis comprising:
receiving input data;
generating a plurality of sets of data samples, each set of data samples representing a portion of the received input data at plurality of scales, wherein each data sample in a set represents the portion of the received input data at a different scale;
generating a feature map from each data sample of at least one set of data samples by learning and aggregating features using a first multi-layer convolutional processing, wherein each data sample is processed with multi-layer convolutional processing separately from other data samples; and
generating a feature map for the at least one set of data samples by combining the feature maps from the data samples of each set of data samples by performing multiple-scale-multiple-location fusion using a second multi-layer convolutional processing.

2. The method of claim 1, wherein the data samples in each set of data samples are overlapping data samples.

3. The method of claim 1, wherein the data samples in each set of data samples are non-overlapping data samples.

4. The method of claim 1, wherein each layer of convolutional processing of the first multi-layer convolutional processing comprises at least one type of processing selected from a set comprising convolutional layer processing, pooling layer processing, Rectified Linear Units layer processing, dropout layer processing, and loss layer processing.

5. The method of claim 4, wherein each layer of convolutional processing of the second multi-layer convolutional processing comprises at least one type of processing selected from a set comprising convolutional layer processing, pooling layer processing, Rectified Linear Units layer processing, dropout layer processing, and loss layer processing, and wherein the second multi-layer convolutional processing and the second multi-layer convolutional processing comprises different layers of convolutional processing.

6. The method of claim 5, wherein the input data comprises image data.

7. A computer program product for data analysis, the computer program product comprising a non-transitory computer readable storage having program instructions embodied therewith, the program instructions executable by a computer, to cause the computer to perform a method comprising:
receiving input data;
generating a plurality of sets of data samples, each set of data samples representing a portion of the received input data at plurality of scales, wherein each data sample in a set represents the portion of the received input data at a different scale;
generating a feature map from each data sample of at least one set of data samples by learning and aggregating features using a first multi-layer convolutional processing, wherein each data sample is processed with multi-layer convolutional processing separately from other data samples; and
generating a feature map for the at least one set of data samples by combining the feature maps from the data samples of each set of data samples by performing multiple-scale-multiple-location label fusion using a second multi-layer convolutional processing.

8. The computer program product of claim 7, wherein the data samples in each set of data samples are overlapping data samples.

9. The computer program product of claim 7, wherein the data samples in each set of data samples are non-overlapping data samples.

10. The computer program product of claim 7, wherein each layer of convolutional processing of the first multi-layer convolutional processing comprises at least one type of processing selected from a set comprising convolutional layer processing, pooling layer processing, Rectified Linear Units layer processing, dropout layer processing, and loss layer processing.

11. The computer program product of claim 10, wherein each layer of convolutional processing of the second multi-layer convolutional processing comprises at least one type of processing selected from a set comprising convolutional layer processing, pooling layer processing, Rectified Linear Units layer processing, dropout layer processing, and loss layer processing, and wherein the second multi-layer convolutional processing and the second multi-layer convolutional processing comprises different layers of convolutional processing.

12. The computer program product of claim 11, wherein the input data comprises image data.

13. A system for predicting metastasis of a cancer, the system comprising a processor, memory accessible by the processor, and computer program instructions stored in the memory and executable by the processor to perform:
receiving input data;
generating a plurality of sets of data samples, each set of data samples representing a portion of the received input data at plurality of scales, wherein each data sample in a set represents the portion of the received input data at a different scale;
generating a feature map from each data sample of at least one set of data samples by learning and aggregating features using a first multi-layer convolutional processing, wherein each data sample is processed with multi-layer convolutional processing separately from other data samples; and
generating a feature map for the at least one set of data samples by combining the feature maps from the data samples of each set of data samples by performing multiple-scale-multiple-location label fusion using a second multi-layer convolutional processing.

14. The system of claim 13, wherein the data samples in each set of data samples are overlapping data samples.

15. The system of claim 13, wherein the data samples in each set of data samples are non-overlapping data samples.

16. The system of claim 13, wherein each layer of convolutional processing of the first multi-layer convolutional processing comprises at least one type of processing selected from a set comprising convolutional layer processing, pooling layer processing, Rectified Linear Units layer processing, dropout layer processing, and loss layer processing.

17. The system of claim 16, wherein each layer of convolutional processing of the second multi-layer convolutional processing comprises at least one type of processing selected from a set comprising convolutional layer processing, pooling layer processing, Rectified Linear Units layer processing, dropout layer processing, and loss layer processing, and wherein the second multi-layer convolutional processing and the second multi-layer convolutional processing comprises different layers of convolutional processing.

18. The system of claim 17, wherein the input data comprises image data.
